(19) United States
(12) Patent Application Publication
(10) Pub. No.: US 2008/0289189 A1
(43) Pub. Date: Nov. 27, 2008

(54) PIZZA CUTTER WITH INTEGRATED DISPENSER

(75) Inventor: Puzant Khatchadourian, New York, NY (US)

Correspondence Address: DARBY & DARBY P.C., P.O. BOX 770, Church Street Station, New York, NY, 10008-0770, US

(73) Assignee: K & G Enterprises, LLC, New York, NY (US)

(21) Appl. No.: 12/059,834

(22) Filed: Mar. 31, 2008

Related U.S. Application Data
(60) Provisional application No. 60/909,217, filed on Mar. 30, 2007.

(51) Int. Cl. B26B 11/00

(52) U.S. Cl. 30/125

(57) ABSTRACT

A utensil that can be utilized to slice pizzas and dispense condiments is provided. The utensil includes a handle and a rotating circular blade for cutting, for example, a pizza into multiple slices. Additionally, the utensil includes one or more compartments, which can be used to hold and dispense various items such as condiments. The compartment(s) can be sealed with tape, aluminum, or a snap-fit cover to secure one or more items held within the compartment(s). The condiments may be provided directly in the compartments, or may be provided in a sealed package or envelope which is received in a respective compartment. Additionally, the compartment(s) can be fitted with a perforated covering to allow for gradual dispensing of one or more items held in the compartment. Furthermore, the circular blade of the utensil can be formed with a wavy edge, rather than a straight edge, to provide greater strength to the blade. The utensil can be formed entirely in plastic to allow the utensil to be more easily disposed and/or recycled.

This application claims the benefit of U.S. Provisional Application 60/909,217, filed Mar. 30, 2007, the entire disclosure of which is incorporated by reference.

### FIELD OF THE INVENTION

The present invention relates generally to cutting utensils and more specifically to utensils which can be used to slice pizzas and dispense condiments.

### BACKGROUND OF THE INVENTION

Conventionally, a pizza is served for consumption by cutting the pizza into multiple slices and is typically enjoyed with various condiments such as, for example, parmesan cheese, hot pepper, garlic powder, salt, and the like. Accordingly, what is needed is a single utensil that can be used to cut pizzas into multiple slices as well as dispense condiments to allow for convenient consumption of pizzas.

### SUMMARY OF THE INVENTION

The present invention is directed to a utensil that can be utilized to slice pizzas and dispense condiments. The utensil includes a handle and a rotating circular blade for cutting, for example, a pizza into multiple slices. Additionally, in one embodiment the utensil includes one or more compartments, which can be used to hold and/or dispense various items such as condiments. The compartment(s) can be sealed with tape, aluminum, or a snap-fit cover to secure one or more items held within the compartment. Additionally, the compartment(s) can be fitted with a perforated covering to allow for gradual dispensing of one or more items held in the compartment(s). Alternatively, items may be stored in individual containers within the compartment(s). Furthermore, the circular blade of the utensil can be formed with a wavy edge, rather than a straight edge, to provide greater strength to the blade. The utensil can be formed of plastic to allow the utensil to be more easily disposed and/or recycled.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements throughout the drawings, in which:

FIG. 1 is an illustration of an embodiment of a utensil in accordance with the present invention;

FIG. 2 is an illustration of an embodiment of a handle of a utensil in accordance with the present invention;

FIG. 3 is an illustration of a blade of a utensil in accordance with the present invention; and

FIG. 4 is an illustration of an alternative embodiment of a handle of a utensil in accordance with the present invention.

### DETAILED DESCRIPTION OF A PREFERRED EMBODIMENT

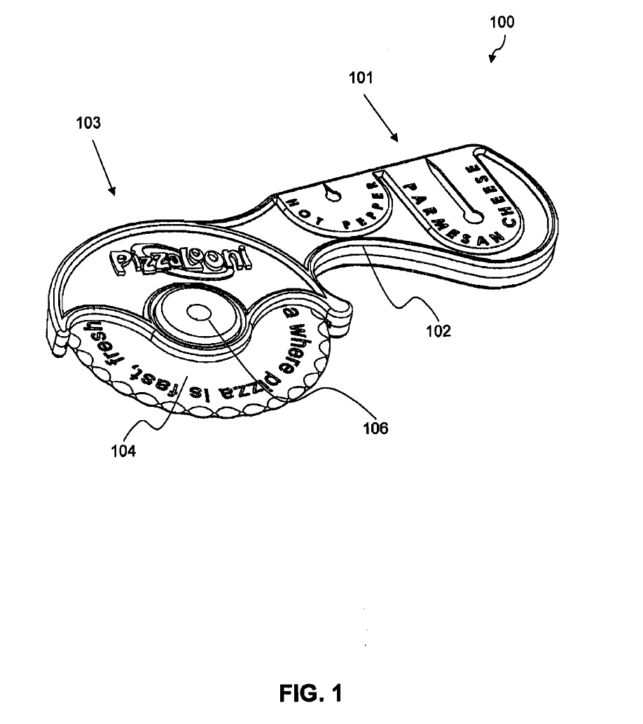

Preferred embodiments of the present invention are now described with reference to the drawings. Referring to FIG. 1, utensil 100 is illustrated and represents an embodiment of a utensil in accordance with the present invention. Utensil 100 includes a circular blade 104 and a handle 102 with a grip section 101 and a blade holding section 103. Circular blade 104 is mounted to blade holding section 103 of handle 102 by axle 106 to allow circular blade 104 to rotate independently of handle 102. As will be appreciated by persons skilled in the art, circular blade 104 can be mounted to handle 102 by means other than an axle, such as, for example, a bearing, to allow circular blade 104 to rotate independently of handle 102. The rotation of circular blade 104 creates a cutting wheel and allows an operator to hold utensil 100 by its handle 102 and cut an object, such as a pizza, by causing circular blade 104 to be rolled over the object.

Utensil 100 is preferably constructed from one or more plastic materials. However, utensil 100 can be constructed from one or more other materials such as various metals, woods, ceramics, and other materials as will be appreciated by persons skilled in the art. By constructing utensil 100 out of plastic, circular blade 104 is less dangerous than comparable metal blades and allows utensil 100 to be more easily disposed and/or recycled.

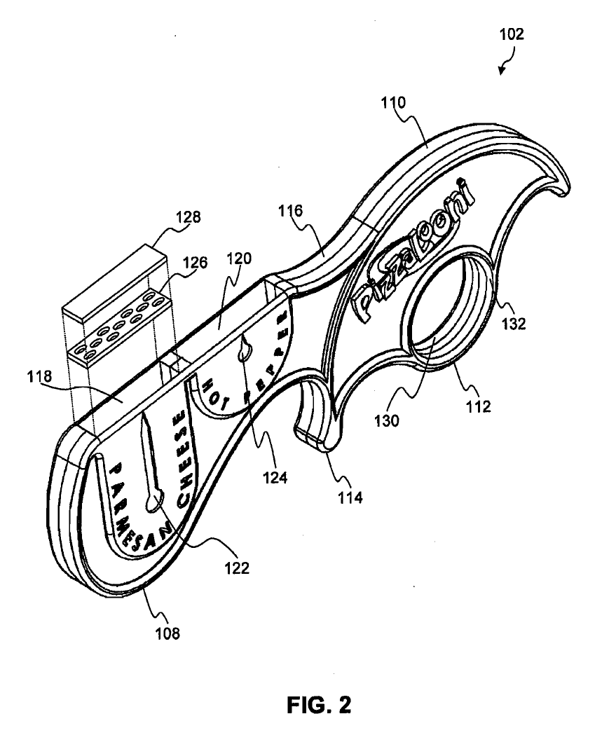

Referring to FIG. 2, handle 102 in accordance with the present invention is illustrated. Handle 102 includes grip 108, blade guard 110, blade axle holder 112, fender 114, thumb guide 116, compartments 118 and 120, and compartment windows 122 and 124. A compartment of handle 102 can be fitted with perforated covering 126 and/or cover 128. As will be appreciated by persons skilled in the art, other embodiments of the present invention can include fewer or more features. For example, a different embodiment may include, for example, only a single compartment and exclude a fender. In another example, an embodiment may include three or more compartments.

Blade axle holder 112 holds axle 106 of circular blade 104 to allow circular blade 104 to rotate independently of handle 102. Blade axle holder 112 includes two supports 130 and 132 that are positioned to form a gap between them. Each of the supports 130 and 132 includes a circular opening which holds one end of axle 106 so that circular blade 104 is positioned within the gap between the two supports 130 and 132. In an alternative embodiment, the utensil of the present invention can include only a single support to hold the axle of the circular blade.

Circular blade 102 can be positioned within handle 102 in a variety of ways as will be appreciated by persons skilled in the art. For example, handle 102 can be manufactured as two or more separate pieces and utensil 102 can be formed by assembling the two or more pieces of handle 102 with circular blade 102. When handle 102 is manufactured as two or more pieces, each support of blade axle holder 112 is preferably included in a separate piece. The two or more pieces can also include posts and post receptacles that align and/or join the two or more pieces together. The two or more pieces and the circular blade can be assembled by positioning one end of the axle of the circular blade into one of the supports included in one of the pieces and then positioning, on the other end of the axle, a second piece having the other support to place the circular blade between the two supports. The two or more pieces can be held in place, for example, by posts and post receptacles that fit snugly, with glue, or with other means as will be appreciated by persons skilled in the art. In another embodiment, one or both of the outer ends of the axle of the circular blade can include a raised lip, which is deformable, that can be pushed through a support of the blade axle holder to keep the axle of the circular blade from sliding out of the blade axle holder.

To make the handle 102 ergonomically appealing and comfortable to hold, the handle 102 may be formed with one or more convex portions 140 that provide it with a significant bulk such that it is easy to hold. Depending on the material with which the handle 102 is formed, the convex portions 140 may be hollow inside. As a result, materials are conserved and the weight of the utensil 100 can be reduced. For example, if the handle is formed of two pieces as described above, each piece may include a convex portion 140 that is opposite a corresponding convex portion 140. Between the convex portions 140, the handle may be hollow. Advantageously, the hollow areas formed between the two convex portions 140 may be used as the compartment 118 or 120.

Grip 108 is preferably shaped to allow an operator to comfortably hold utensil 100 with a single hand with the thumb positioned to press down against thumb guide 116 and with the index finger positioned behind fender 114. Thumb guide 116 allows the operator to apply downward pressure on the cutting edge of circular blade 104 as circular blade 104 is rolled to cut an object. Blade guard 110 and fender 114 protect the operator's hand from the cutting edge of circular blade 104 when utensil 100 is utilized to cut objects.

Each of the compartments 118 and 120 can be used to hold and/or dispense one or more items. Such an item can include, for example, a condiment or a condiment packet. The contents of a compartment can be secured by cover 128 such as, for example, tape, aluminum, snap-fit cover, or other coverings as will be appreciated by persons skilled in the art. Additionally, a compartment can be fitted with perforated covering 126 to allow for gradual dispensing of an item stored in the compartment such as a condiment.

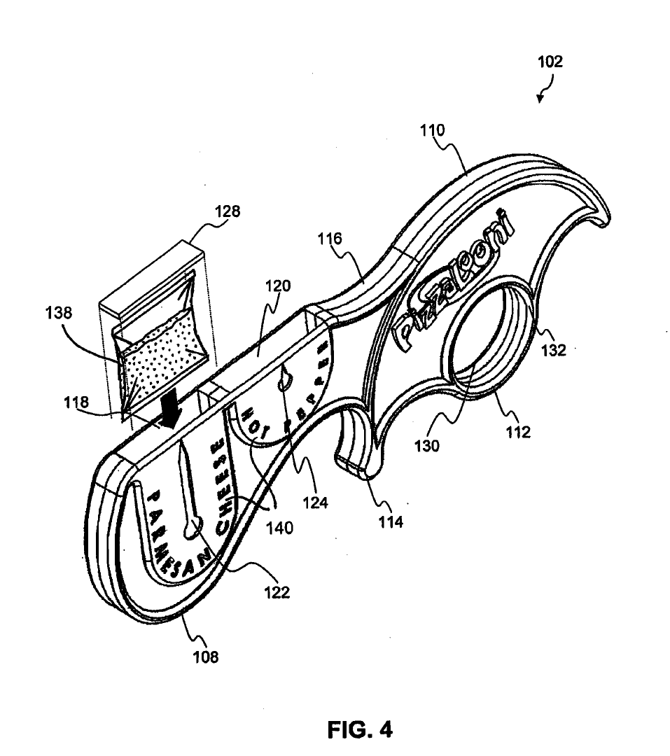

When a food item such as a condiment is stored in a compartment, the food item can be stored in a manner to keep the food item fresh and sanitary. For example, the compartment can be sealed using a cover that is not harmful to the food item such as, for example, food grade tape or other coverings as will be appreciated by persons skilled in the art. Alternatively, the food item can be placed in a condiment packet 138 and the condiment packet 138 can be stored in the compartment, as shown in FIG. 4. The packet can be in the form of a small plastic bag or envelope as is typically used in the food product industry for storing seasoning or food items such as salt, pepper, etc., that are packaged in sealed packages. Storing food items in the one or more compartments such that the food items remain fresh and sanitary allows the utensil of the present invention to be easily dispensed from automated vending machines.

Compartments 118 and 120 can also include compartment windows 122 and 124 respectively. A compartment window is preferably constructed out of a clear material to allow an operator to view the inner contents of the compartment. For example, if a compartment is filled with grated parmesan cheese, the compartment window allows the operator to view how much grated parmesan cheese is remaining in the compartment.

Although handle 102 includes compartments 118 and 120 in the portion of the handle forming grip 108, one or more compartments can be positioned elsewhere on handle 102 such as, for example, under thumb guide 116, end cap of grip 108, or attached to blade guard 110.

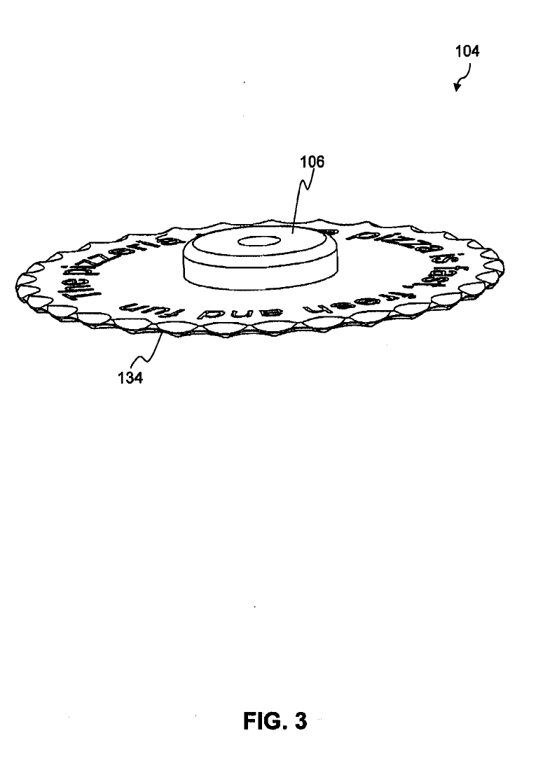

Referring to FIG. 3, circular blade 104 includes axle 106 and wavy blade edge 134. Axle 106 allows handle 102 to hold circular blade 104 while also allowing circular blade 104 to rotate independently of handle 102. Circular blade 104 can be constructed from plastic materials to make the cutting edge of circular blade 104 safer than a comparable blade constructed with metal. The blade axle 106 can be integrally formed with the circular blade 104. Although circular blade 104 is shown as including wavy blade edge 134, other embodiments of the present invention may include a circular blade with a straight blade edge, a serrated blade edge, or other types of blade edges as will be appreciated by persons skilled in the art.

Circular blade 104 includes wavy blade edge 134 to provide a stronger blade edge than a comparable straight blade edge. In one embodiment, wavy blade edge 134 is formed by producing concave spherical arcs into one or both sides of the outer perimeter of circular blade 104. By forming the blade edge in this manner, the regions where two adjacent concave spherical arcs meet provide additional structural support to the blade edge. Accordingly, wavy blade edge 134 can provide greater strength to the outer perimeter of circular blade 104 than a comparable straight blade edge.

Although various embodiments of the present invention have been described primarily with its application to pizzas and condiments, it should be noted that an embodiment of the present invention can be utilized in any application where cutting of an object and storing of items can be conveniently combined into a single utensil. For example, an embodiment of the present invention can be used to cut other food items such as, for example, pies, dough, and vegetables, as well as non-food items such as, for example, clay, caulking, and other materials. Furthermore, the compartments in the embodiments of the present invention can be used to store not only food items but also non-food items such as, for example, toothpicks, napkins, and various other items.

Although preferred embodiments of the invention have been disclosed for illustrative purposes, those skilled in the art will appreciate that many additions, modifications and substitutions are possible, without departing from the scope and spirit of the invention.

We claim:

1. A utensil comprising:
a handle including a grip section and a blade holding section;
a circular blade rotatably coupled to the blade holding section of the handle;
at least one food product compartment disposed within the grip section of the handle; and
a food product contained within the at least one compartment.

2. The utensil of claim 1 wherein the handle and circular blade comprise plastic.

3. The utensil of claim 1 wherein the handle includes a compartment window providing access to the compartment and a cover disposed over the compartment window.

4. The utensil of claim 1 wherein the handle includes a compartment opening providing access to the compartment and a perforated covering disposed over the compartment opening.

5. The utensil of claim 4 wherein the handle includes a solid cover disposed over the perforated covering.

6. The utensil of claim 1 wherein the blade holder section of the handle includes a blade guard and fender surrounding a portion of the circular blade.

7. The utensil of claim 1 wherein the circular blade comprises plastic.

8. The utensil of claim 7 wherein the circular blade includes a wavy blade edge.

9. The utensil of claim 1 wherein said handle includes a window providing visual access to the compartment.

10. A utensil comprising:
a handle including a grip section and a blade holding section;
a circular blade rotatably coupled to the blade holding section of the handle;
at least one food product compartment disposed within the grip section of the handle; and
a packet comprising a food product therein contained within the at least one compartment.

11. The utensil of claim 10 wherein the packet includes an envelope.

12. The utensil of claim 10 wherein the handle includes a compartment opening providing access to the compartment and a cover disposed over the compartment opening.

13. The utensil of claim 10 wherein the handle includes a compartment opening providing access to the compartment and a perforated covering disposed over the compartment opening.

14. The utensil of claim 13 wherein the handle includes a cover disposed over the perforated covering.

15. The utensil of claim 10 wherein the blade holder section of the handle includes a blade guard and fender surrounding a portion of the circular blade.

16. The utensil of claim 10 wherein the circular blade comprises plastic.

17. The utensil of claim 16 wherein the circular blade includes a wavy blade edge.

18. A utensil comprising:
a handle including a grip section and a blade holding section;
a circular blade rotatably coupled to the blade holding section of the handle;
at least one food product compartment disposed within the grip section of the handle adapted to receive a packet of food product therein.

19. A utensil comprising:
a handle including a grip section and a blade axle holder including a first support and a second support, the handle comprising a first piece including the first support and a second piece including the second support; and
a circular blade with a blade axle disposed between the first support and the second support such that the circular blade is rotatably coupled to the handle,
wherein the first piece further includes a first hollow convex portion in the grip section of the handle and the second piece further includes a second hollow convex portion opposite the first hollow convex portion in the grip section of the handle, such that a storage compartment is disposed in the grip section of the handle between the first and second hollow convex portions.

20. The utensil of claim 19 wherein the blade axle comprises plastic material integrally formed with the circular blade.

21. The utensil of claim 19 further comprising a food product disposed in the storage compartment.

22. The utensil of claim 21 wherein the food product is enclosed in a packet.
